(19) United States
(12) Patent Application Publication
(10) Pub. No.: US 2013/0156992 A1
(43) Pub. Date: Jun. 20, 2013

(54) ANTISTATIC POLYESTER RESIN MOLDED BODY

(71) Applicant: Canon Kabushiki Kaisha, Tokyo (JP)

(72) Inventors: Yoshinobu Okumura, Machida-shi (JP); Yuichi Hashimoto, Tokyo (JP); Masaki Sunaga, Atsugi-shi (JP); Koichi Suzuki, Yokohama-shi (JP)

(73) Assignee: CANON KABUSHIKI KAISHA, Tokyo (JP)

(21) Appl. No.: 13/712,731

(22) Filed: Dec. 12, 2012

(30) Foreign Application Priority Data
Dec. 15, 2011 (JP) 2011-275098
Dec. 15, 2011 (JP) 2011-275099
Dec. 15, 2011 (JP) 2011-275100
Oct. 15, 2012 (JP) 2012-227978

(51) Int. Cl. C09K 3/16; B32B 5/26

(52) U.S. Cl. CPC C09K 3/16; B32B 5/26; Y10S 977/742; B82Y 30/00
USPC 428/74; 977/742

(57) ABSTRACT

A molded body has a base material, a first region covering the base material, and a second region covering the first region, in which the first region has the base material and carbon nanotubes and the second region has carbon nanotubes and an ionic liquid.

### BACKGROUND OF THE INVENTION

1. Field of the Invention

The present invention relates to an antistatic polyester resin molded body.

2. Description of the Related Art

In recent years, in the fields of various apparatuses having electrostatic sensitive precise control components, an antistatic resin molded article is used for an electrical and electronic component, sheet, film, and the like in which a static interference problem may occur.

Under an environment where a static interference problem may occur, working clothes containing a high density fabric to which antistaticity is given are used.

In particular, it is considered that a demand for molded articles containing an antistatic polyester resin which is relatively rich in heat resistance, has less environmental load, and has excellent durability may expand in the future.

A high antistatic resin molded article containing polyester resin has been required to have characteristics of low surface resistivity (Ω/sq.) and a short half-life of charge decay (s). Furthermore, the resin has been required to have fire retardant properties.

In particular, in order to have the characteristic of a short half-life, it is indispensable that a uniform electrically conductive path is present on the surface of the antistatic resin molded article.

Heretofore, in order to give antistaticity to a polyester resin, molded bodies containing an electrically conductive filler, such as carbon black, are known.

However, since these molded bodies are required to contain a relatively large amount of electrically conductive fillers, there have been problems such that the mechanical properties of the polyester resin remarkably decrease and also the electrically conductive path on the molded body surface is uneven, and therefore it has been difficult to give a high antistaticity.

In order to solve these problems, Patent Document 1 (Japanese Patent Laid-Open No. 2009-280710) discloses an antistatic resin composition containing a polyester polycondensate of which 90% by mol or more of repeating units is ethylene terephthalate, a polyester polycondensate containing a monomer component having a cycloaliphatic hydrocarbon group, and an ionic liquid containing imidazolium ion as a cation.

It is disclosed that the constitution suppresses the contamination to an adherend due to bleed-out.

Patent Document 2 (Japanese Patent Laid-Open No. 2010-196007) proposes an antistatic resin composition containing an ionic liquid in a polyester copolymer containing an alkylene oxide unit as a constituent component and discloses that the surface resistance value is low and a continuous stable antistaticity is exhibited.

Patent Document 3 (Japanese Patent Laid-Open No. 2007-113132) proposes a woven or knitted fabric containing fibers in which an electrically conductive polymer adheres to a surface layer of the fibers, so that electrical conductivity is imparted.

However, these substances cannot be expected as a polyester resin molded body which is required to have continuous high antistaticity for the reasons described below.

In the antistatic polyester molded body disclosed in Patent Document 1, the fire retardant properties improve because an ionic liquid is contained but the electrical conductivity of the ionic liquid is low.

Therefore, also in a film in which the content thereof in the polyester resin is 50%, it is difficult to achieve a surface resistance value of 10⁰ to 10⁷ Ω/sq.

In the antistatic polyester molded body disclosed in Patent Document 2, the content of the ionic liquid is small, and therefore it is difficult to achieve a surface resistance value of 10⁰ to 10⁷ Ω/sq.

Moreover, a so-called bleed-out phenomenon in which the ionic liquid contained in the resin bleeds to the resin molded body surface may occur, and therefore it is difficult to hold continuous stable antistaticity.

In the woven or knitted fabric containing fibers to which electrical conductivity is given disclosed in Patent Document 3, the surface resistance value of the fabric is 10⁶ Ω/sq. or more and 10¹² Ω/sq. or lower.

As disclosed also in Patent Document 3, it is difficult for the polyester fiber to achieve 10⁶ Ω/sq. or lower.

### SUMMARY OF THE INVENTION

Then, the present invention provides a molded body containing a polyester resin having fire retardant properties, a low surface resistance value, and stable continuous antistaticity.

Thus, the invention provides a molded body having a first region and a second region disposed covering the first region, in which the first region contains polyester and carbon nanotubes and the second region contains carbon nanotubes and an ionic liquid.

Further features of the present invention will become apparent from the following description of exemplary embodiments with reference to the attached drawings.

### BRIEF DESCRIPTION OF THE DRAWINGS

FIGS. 1A and 1B are schematic views of the cross section of an electrically conductive fiber according to this embodiment.

FIGS. 2A and 2B are schematic views of the cross section of an electrically conductive film according to this embodiment.

FIGS. 3A and 3B are schematic views of a dispersed state of carbon nanotubes present in the cross section of the electrically conductive fiber and the electrically conductive film according to this embodiment.

FIGS. 4A and 4B are schematic views of a dispersed state of carbon nanotubes present in the cross section of the electrically conductive fiber according to this embodiment.

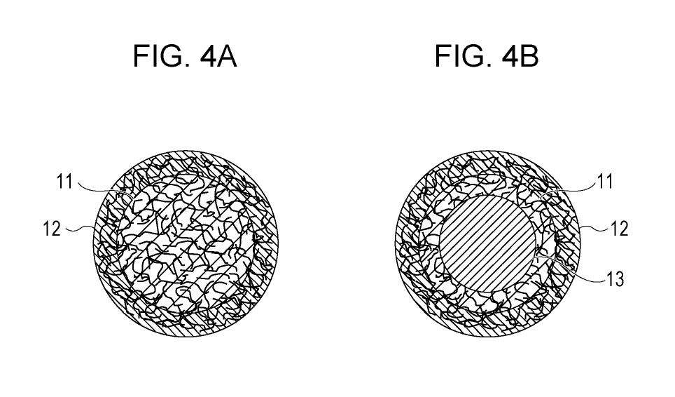

FIGS. 5A and 5B are schematic views of a dispersed state of carbon nanotubes present in the cross section of the electrically conductive film according to this embodiment.

### DESCRIPTION OF THE EMBODIMENTS

The invention may be a molded body having a base material, a first region covering the base material, a second region covering the first region, in which the first region has the base material and carbon nanotubes and the second region has carbon nanotubes and an ionic liquid.

The invention is suitably a molded body having a first region and a second region disposed covering the first region, in which the first region contains polyester and carbon nanotubes and the second region contains carbon nanotubes and an ionic liquid.

As the ionic liquid, ionic liquids represented by the following general formulae (1) to (3).

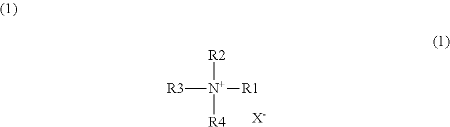

In Formula (1), R1 to R4 each are independently selected from a hydrogen atom and an alkyl group having carbon atoms of 1 or more and 4 or lower.

At least two groups of R1 to R4 are primary alcohols having carbon atoms of 1 or more and 4 or lower. X⁻ represents an anion.

R1 to R4 in General Formula (1) are alkyl groups having carbon atoms of 1 or more and 4 or lower. Specifically mentioned are an ethyl group, a methyl group, a propyl group, and a butyl group.

At least two groups of R1 to R4 in the formula are primary alcohols having carbon atoms of 1 or more and 4 or lower.

The primary alcohol is alcohol in which a carbon atom bonded to a hydroxyl group has two hydrogen atoms.

The hydroxyl group of the primary alcohol is bonded to a carboxyl group and a hydroxyl group present on the surface of the carbon nanotubes.

Therefore, the ionic liquid is held in the carbon nanotubes and can be stably present in the molded body.

The molded body can also be produced using an ionic liquid represented by the following general formula (2).

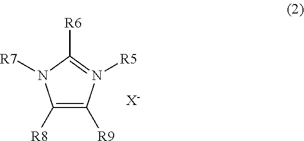

In Formula (2), R5 and R7 each are independently selected from functional groups having a hydroxyl group at the terminal of an alkyl group having carbon atoms of 1 or more and 4 or lower.

R6, R8, and R9 each are independently selected from hydrogen or an alkyl group having carbon atoms of 1 or more and 4 or lower. X⁻ represents an anion.

The molded body can also be produced using an ionic liquid represented by the following general formula (3).

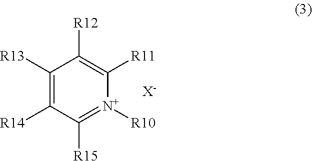

In Formula (3), R10 is selected from functional groups having a hydroxyl group at the terminal of an alkyl group having carbon atoms of 1 or more and 4 or lower. R11, R12, R13, R14, and R15 each are independently selected from hydrogen or an alkyl group having carbon atoms of 1 or more and 4 or lower. X⁻ represents an anion.

The molded bodies produced using these ionic liquids can take the shape of an electrically conductive fiber, an electrically conductive film, and the like.

As a result, the electrically conductive fiber according to this embodiment is a stable fiber which has high fire retardant properties and exhibits a surface resistance value as low as 10³ to 10⁷ Ω/sq. and also in which the bleed-out phenomenon is suppressed.

The polyester molded body according to this embodiment is described with reference to the drawings.

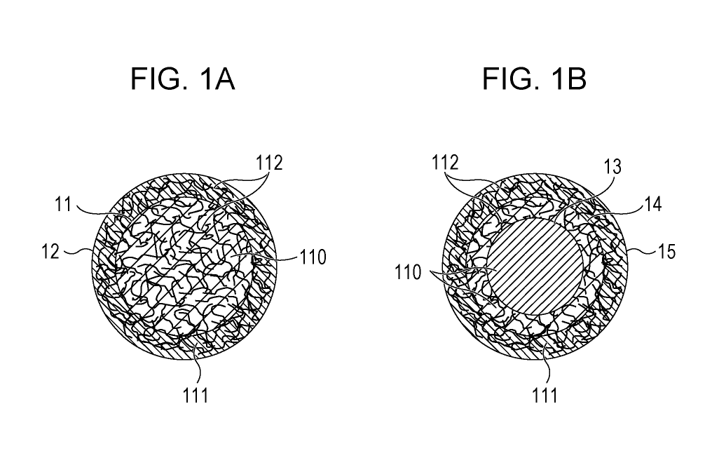

FIGS. 1A and 1B schematically illustrate the cross section of the electrically conductive fiber which is one embodiment of the molded body according to the invention.

FIG. 1A illustrates the cross section of the electrically conductive fiber having a two-layer structure containing a first region and a second region. FIG. 1B illustrates the cross section of the electrically conductive fiber having a three-layer structure containing a first region, a second region, and a base material.

In FIG. 1A, the reference numeral 11 denotes a polyester resin and denotes a first region having a structure in which carbon nanotubes 112 are entangled in a polyester resin 110. The first region 11 is covered with a second region 12 containing the carbon nanotubes 112 and an ionic liquid 111.

Furthermore, the ionic liquid 111 adheres to the surface of the carbon nanotubes 112 by chemical bonding in the second region.

In FIG. 1B, the reference numeral 13 denotes a base material containing only a polyester resin. The base material 13 is in contact with a first region 14 having a structure in which the carbon nanotubes 112 are entangled in the polyester resin 110.

The first region 14 is covered with a second region 15 containing the carbon nanotubes 112 and the ionic liquid 111. The ionic liquid 111 adheres to the surface of the carbon nanotubes 112 by chemical bonding in the second region.

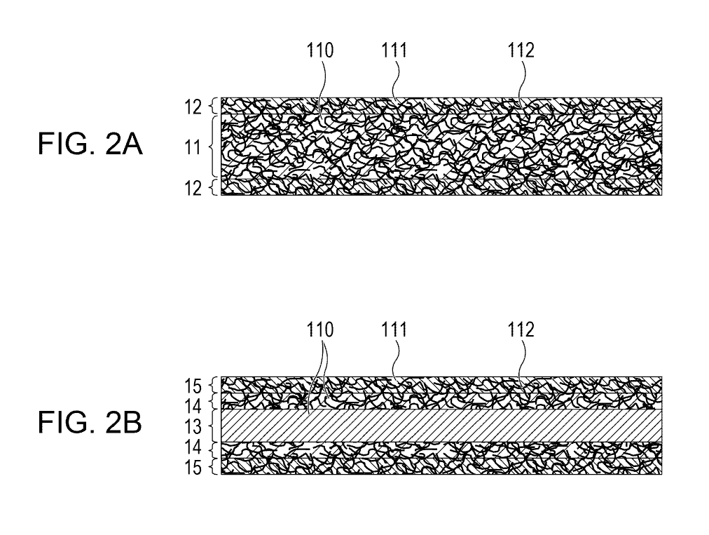

FIGS. 2A and 2B schematically illustrate the cross section of the electrically conductive film which is one embodiment of the molded body according to the invention.

FIG. 2A illustrates the cross section of the electrically conductive film having a two-layer structure containing a first region and a second region. FIG. 2B illustrates the cross section of the electrically conductive film having a three-layer structure containing a base material, a first region, and a second region.

In FIG. 2A, the reference numeral 11 denotes a polyester resin and denotes a first region having a structure in which carbon nanotubes 112 are entangled in a polyester resin 110.

The first region 11 is disposed between upper and lower second regions 12 containing the carbon nanotubes 112 and the ionic liquid 111.

The ionic liquid 111 adheres to the surface of the carbon nanotubes 112 by chemical bonding in a surface layer portion.

In FIG. 2B, the reference numeral 13 denotes a base material containing only a polyester resin. The base material 13 is disposed between upper and lower first regions 14 having a structure in which the carbon nanotubes 112 are entangled in the polyester resin 110.

The first regions 14 are disposed between upper and lower second regions 15 containing the carbon nanotubes 112 and the ionic liquid 111. The ionic liquid 111 adheres to the surface of the carbon nanotubes 112 by chemical bonding in the second region.

The polyester molded body according to the invention contains the ionic liquid represented by General Formula (1).

In General Formula (1), it is suitable for X which is an anion component to have a fluoro group from the viewpoint of thermal stability. For example, CF₃SO₃ or (CF₃SO₂)₂N is mentioned.

The ionic liquid is one kind of salt containing only ion and exhibits a liquid state around room temperature, and therefore is also referred to as an ambient temperature molten salt. Even when the ionic liquid is in a liquid state, the interaction action works between ions, and therefore the ionic liquid is a liquid in which vapor pressure hardly generates and which has nonvolatility, fire retardant properties, and also electrical conductivity.

The carbon nanotubes constituting a core portion and the surface layer portion illustrated in FIG. 1A and FIG. 2A and the first region and the second region illustrated in FIG. 1B and FIG. 2B suitably have a length L of 1 μm or more and 5 μm or lower and an aspect ratio L/D which is a ratio of the length L to a diameter D of 150 or more and 400 or lower.

By adjusting the length L of the carbon nanotubes to be 5 μm or lower and the aspect ratio L/D to be 400 or lower, the orientation of the carbon nanotubes in a spinning direction is suppressed when an undrawn fiber is manufactured by a melt spinning method, and then an electrically conductive fiber is manufactured by hot drawing treatment.

By adjusting the length L of the carbon nanotubes to be 5 μm or lower and the aspect ratio L/D to be 400 or lower, the first region, the second region, and the carbon nanotubes each illustrated in FIGS. 1A and 1B can be entangled better.

By adjusting the length L of the carbon nanotubes to be 5 μm or lower and the aspect ratio L/D to be 400 or lower, the orientation of the carbon nanotubes in a film drawing direction is suppressed when an undrawn film is manufacture by a melt extrusion molding method or an injection molding method, and then an electrically conductive film is manufactured by drawing treatment.

As a result, the carbon nanotubes present in the first region and the second region can be entangled better.

It is suitable that the carbon nanotubes in the first region and the second region are three-dimensionally entangled.

The carbon nanotubes give electrical conductivity, and the shape thereof is not particularly limited. For example, a single layer carbon nanotube which is a cylindrical tube containing a single wall carbon nanotube (SWCNT) or a single graphene, a multilayer carbon nanotube in which cylindrical tubes containing two or more graphenes different in the diameter, and a carbon nanotube not having a tubular shape may be acceptable.

The molded body according to the invention has a base material. The constituent component of the base material is not particularly limited and a polymer, such as polyester, metal, plastic, and the like are mentioned. In particular, one whose surface can be dissolved by alkaline treatment is suitable.

The base material may be present singly or carbon nanotubes may be intermingled in the base material.

As the polyester resin mentioned as the constituent component of the first region illustrated in FIG. 1A and FIG. 2A and the base material and the first region illustrated in FIG. 1B and FIG. 2B are, polyethylene terephthalate, polytrimethylene terephthalate, polybutylene terephthalate, polyethylene naphthalate, and polybutylene naphthalate are mentioned, for example. The polyester resin may be a mixed resin containing two or more kinds of polyester resin.

The electrically conductive fiber which is one embodiment of the molded body according to the invention can be manufactured by the use of a melt spinning method.

The electrically conductive fiber having the two-layer structure illustrated in FIG. 1A is manufactured by preparing polyester resin pellets in which carbon nanotubes are uniformly dispersed and using a melt spinning nozzle for a single component having a large number of round holes in melt spinning.

On the other hand, the electrically conductive fiber having the three-layer structure illustrated in FIG. 1B is manufactured by preparing polyester resin pellets and polyester resin pellets in which carbon nanotubes are uniformly dispersed and using a core-sheath type conjugate spinning nozzle in melt spinning.

In this case, the electrically conductive fiber is manufactured in such a manner that the base material contains the polyester resin and the first region contains the polyester resin in which the carbon nanotubes are uniformly dispersed.

When manufacturing the electrically conductive fiber illustrated in FIGS. 1A and 1B by a melt spinning method, the polyester resin in a molten state in which the carbon nanotubes are uniformly dispersed flows through the inner surface of a spinneret of the melt spinning nozzle having a plurality of round holes, and then extruded from a round spinning orifice at the tip end portion of the spinneret.

When the polyester resin in a molten state in which the carbon nanotubes are uniformly dispersed flows through the spinneret inner surface of the melt spinning nozzle, the polyester resin flows in such a manner that the tip end portion of the resin in a molten state spouts from the center of the cross section of the spinneret to the surrounding spinneret inner surface.

Such flow is referred to as a fountain flow. In this case, the resin in a molten state contacting the spinneret inner surface is rapidly cooled at the spinneret inner surface to form a skin layer. The skin layer does not contain the carbon nanotubes and is formed with only the polyester resin.

The electrically conductive fiber having the skin layer on the surface extruded from the melt spinning nozzle in a molten state is cooled, an aqueous or non-aqueous treatment agent is attached thereto, and then the electrically conductive resin is wound at a winding rate of suitably 100 m/min or more and 10000 m/min or lower and particularly suitably 300 m/min or more and 2000 m/min or lower.

Herein, the fiber extruded from the melt spinning nozzle is suitably a multifilament containing a plurality of fiber bungles rather than a single monofilament. The number of the one fiber bungle is suitably 20 to 200.

By drawing the undrawn electrically conductive fiber produced by a melt spinning method under heat by a heating type drawing device, an orientationally crystallized electrically conductive fiber can be obtained.

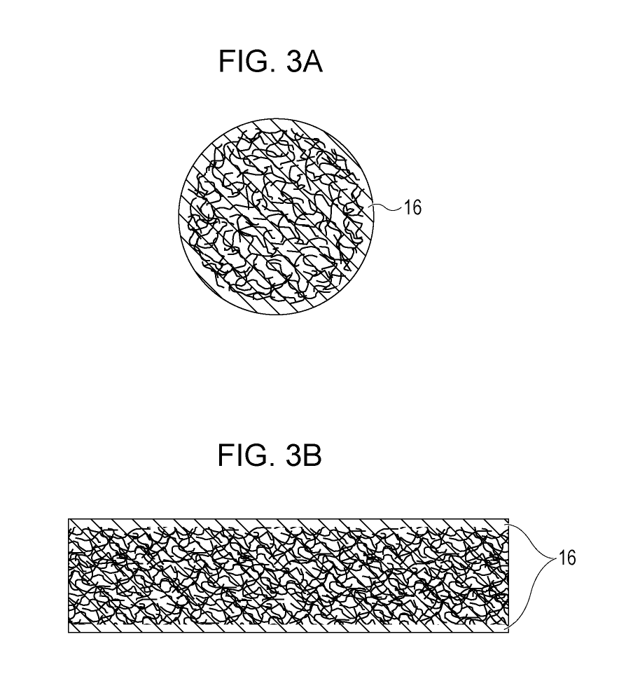

On the surface of the electrically conductive fiber subjected to heating and drawing treatment, a skin layer 16 is present as illustrated in FIG. 3A taking the electrically conductive fiber manufactured using a melt nozzle as an example. Therefore, it is difficult to adjust the surface resistance value of an electrically conductive fiber structure containing the electrically conductive fiber in this state to be 10⁷Ω or lower.

In order to remove the skin layer and further selectively remove only the polyester resin in a layer in which the carbon nanotubes are entangled in the polyester resin present inside the skin layer, oxygen plasma treatment or alkaline water treatment is suitably used.

The oxygen plasma treatment includes introducing oxygen gas into a vacuum vessel to maintain a decompressed state, and then inducing oxygen plasma between the vacuum vessel and a porous metal cylindrical electrode disposed in the vacuum vessel to thereby treat the surface of the electrically conductive fiber or the electrically conductive film disposed in the porous metal cylindrical electrode.

By disposing the electrically conductive fiber or the electrically conductive film in the porous metal cylindrical electrode to control ions or electrons in plasma, the skin layer on the surface of the electrically conductive fiber or the electrically conductive film can be removed by an oxygen atom radical.

The plasma generation conditions are selected as appropriate depending on the device structure or the size of a treatment target substance. The high frequency electrical power is suitably 30 W or more and 500 w or lower. The oxygen gas flow rate is suitably 30 sccm or more and 200 sccm or lower.

The oxygen plasma treatment period of time is suitably 2 minutes or more and 60 minutes or lower. When the oxygen plasma treatment period of time is less than 2 minutes, the oxygen plasma treatment is insufficient. It is considered that the effect of the oxygen plasma on and after 61 minutes is low. This is because it is found that the treatment effect decreases due to temperature elevation.

In the alkaline water treatment, the electrically conductive fiber or the electrically conductive film is suitably held in several weight percentages of a sodium hydroxide solution or several weight percentages of a potassium hydroxide solution held at 50° C. or higher and 100° C. or lower for several 10 minutes to several 100 minutes. Particularly suitably, the electrically conductive fiber or the electrically conductive film is held in 3% to 5% sodium hydroxide solution of a temperature of 60° C. to 70° C. for 100 minutes to 300 minutes.

By controlling the period of time of the oxygen plasma treatment or the alkaline water treatment, the electrically conductive fiber manufactured by the melt spinning nozzle for a single component and the electrically conductive fiber manufactured by the core-sheath type conjugate spinning nozzle can provide an electrically conductive fiber having a surface layer portion containing a plurality of carbon nanotubes which are three-dimensionally entangled.

Next, by impregnating the surface of the electrically conductive fiber having the surface layer portion containing the carbon nanotubes with an ammonium type ionic liquid represented by General Formula (1), an electrically conductive fiber constituting an antistatic fiber structure as illustrated in FIG. 1, which is one embodiment of the antistatic polyester resin molded body according to the invention, can be obtained.

When impregnating the surface of the electrically conductive fiber with the ionic liquid, a method is suitably used which includes diluting the ionic liquid to be 0.1% or more and 5% or lower with pure water, and then immersing the electrically conductive fiber in the dilution water or adding dropwise the dilution water to the surface of the electrically conductive fiber.

The surface resistance value of the antistatic fiber structure can be controlled to 10³ to 10⁷ Ω/sq. by controlling the period of time of the oxygen plasma treatment or the alkaline water treatment and the impregnation amount of the ammonium type ionic liquid after the oxygen plasma treatment or the alkaline water treatment.

Due to the fact that the carbon nanotubes are impregnated with the ionic liquid, fire retardant properties are imparted.

The electrically conductive film constituting an antistatic molded body which is one embodiment of the molded body according to the invention can be manufactured by a melt extrusion molding method.

The electrically conductive film having the two-layer structure illustrated in FIG. 2A is manufactured by preparing polyester resin pellets in which carbon nanotubes are uniformly dispersed, heating the pellets in a cylinder, continuously extruding the resin in a molten state which is pressurized by a screw from a die having a linear lip referred to as a T-die, and then cooling the resin.

On the other hand, the electrically conductive film having the three-layer structure illustrated in FIG. 2B can be manufactured by the use of a co-extrusion molding method which is one of the melt extrusion molding methods.

Specifically, polyester resin pellets and polyester resin pellets in which carbon nanotubes are uniformly dispersed are prepared.

The pellets are separately melted using three extruders in such a manner that the core contains the polyester resin and the upper and lower surface layer portions contain the polyester resin in which carbon nanotubes are uniformly dispersed.

The resins in a molten state supplied from the three extruders are brought into contact with each other immediately before a lip portion of a T-die to form a three-layer structure, and then the structure is continuously extruded from the lip portion, followed by cooling to thereby manufacture the electrically conductive film having the three-layer structure.

When forming the electrically conductive film illustrated in FIG. 2A or 2B by the melt extrusion molding method, the polyester resin in a molten state in which carbon nanotubes are uniformly dispersed flows through the inner surface of the T-die, and then extruded from the tip end portion of the lip.

When the polyester resin in a molten state in which carbon nanotubes are uniformly dispersed flows through the inner surface of the T-die, the tip end portion of the resin in a molten state performs a so-called fountain flow in such a manner that the resin spouts from the center of the cross section of the lip to the surrounding lip inner surface.

In this case, the resin in a molten state contacting the lip inner surface is rapidly cooled at the lip inner surface to form a skin layer. The skin layer does not contain the carbon nanotubes and is formed with only the polyester resin.

By drawing the undrawn electrically conductive film produced by the melt extrusion molding method using a heating type biaxial drawing device under heat in a vertical direction and in a horizontal direction of the film, an orientationally crystallized electrically conductive film can be obtained.

On the surface of the electrically conductive film subjected to heating and drawing treatment, a skin layer 16 is present as illustrated in FIG. 3B taking the electrically conductive film manufactured by the melt extrusion molding method as an example.

Due to the presence of the skin layer, it is difficult to adjust the surface resistance value of the electrically conductive film in this state to be 10³Ω or lower.

In order to remove the skin layer and further selectively remove only the polyester resin in a layer having a structure such that the carbon nanotubes are entangled in the polyester resin present in the skin layer, oxygen plasma treatment or alkaline water treatment is suitably used.

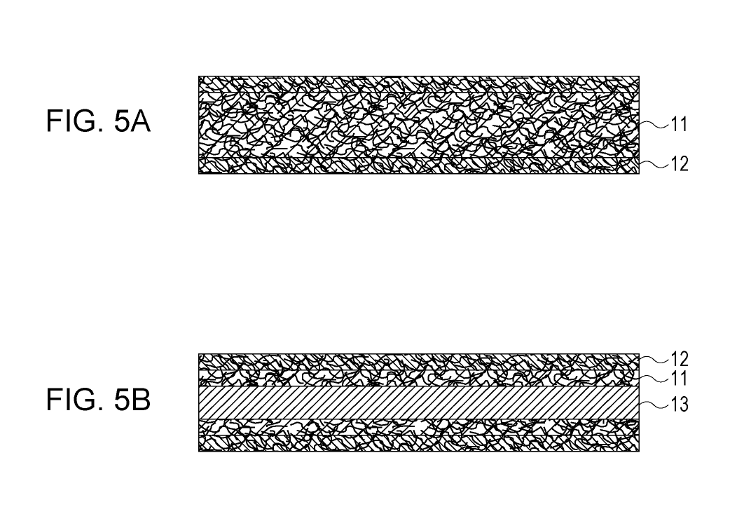

By controlling the period of time of the oxygen plasma treatment or the alkaline water treatment, an electrically conductive film having a surface layer portion containing a plurality of carbon nanotubes which are three-dimensionally entangled illustrated in FIG. 5A can be obtained by the melt extrusion molding method.

With respect to the electrically conductive film having the three-layer structure manufactured by a co-extrusion molding method, an electrically conductive film having a surface layer portion containing a plurality of carbon nanotubes which are three-dimensionally entangled illustrated in FIG. 5B can be obtained.

Next, by impregnating the surface of the electrically conductive film having the surface layer portion containing carbon nanotubes with an ammonium type ionic liquid represented by General Formula (1), an electrically conductive film illustrated in FIGS. 2A and 2B can be obtained.

When impregnating the surface of the electrically conductive film with the ionic liquid, a method is suitably used which includes diluting the ionic liquid to be 0.1% or more and 5% or lower with pure water, and then immersing the electrically conductive film in the dilution water or adding dropwise the dilution water to the surface of the electrically conductive film.

The surface resistance value of the antistatic fiber structure can be controlled to 10⁰ to 10⁷ Ω/sq. by controlling the period of time of the oxygen plasma treatment or the alkaline water treatment and the impregnation amount of the ammonium type ionic liquid after the oxygen plasma treatment or the alkaline water treatment.

Due to the fact that the carbon nanotubes are impregnated with the ionic liquid, fire retardant properties are imparted.

### EXAMPLES

Hereinafter, EXAMPLES of the invention are described but the invention is not limited to the EXAMPLES.

### Example 1

Polyethylene terephthalate resin pellets having an intrinsic viscosity (hereinafter abbreviated as an “IV value”) of 0.8, a diameter of 3 mm, and a length of 5 mm are freeze-pulverized, and then classified to thereby produce fine power having a particle diameter of 150 μm or lower.

Next, the polyethylene terephthalate fine powder having a particle diameter of 150 μm or lower and carbon nanotubes having a length of 5 μm or lower, an average length of 3 μm, an aspect ratio of 400 or lower, and an average aspect ratio of 200 were dry-blended in such a manner that the proportion of the carbon nanotubes was 4% by weight.

Thereafter, by kneading and melting by a biaxial extruder, polyethylene terephthalate resin compound pellets in which the carbon nanotubes were uniformly dispersed were produced.

Next, the polyethylene terephthalate resin compound pellets in which the carbon nanotubes were uniformly dispersed were dried at 140° C. for 4 hours.

Next, the polyethylene terephthalate resin compound pellets in which the carbon nanotubes were uniformly dispersed were introduced into a biaxial extruder, and then a molten substance of the polyethylene terephthalate resin pellets in which the carbon nanotubes were uniformly dispersed was discharged from a melt spinning nozzle having a round spinneret having an opening diameter of 0.3 mm and having 36 holes at a spinning temperature of 290° C. for spinning.

The obtained spun yarn was cooled and solidified by cooling air having an air temperature of 25° C. and an air speed of 0.5 mm/second using a cooling device having a cooling length of 1 m, an oil agent (Effective component: 10% by weight concentration) was attached thereto, and then the yarn was wound at 1000 m/minute, thereby producing an undrawn multifilament yarn having a fiber diameter of 38 μm.

The obtained multifilament yarn was thermally drawn at a temperature of 150° C. in such a manner that the drawing ratio was twice, thereby producing a multifilament yarn containing 36 electrically conductive fibers with a fiber diameter of 27 μm.

Next, a high density fabric was produced into which the multifilament yarn containing the electrically conductive fibers with a fiber diameter of 27 μm was inserted lengthwise and widthwise in a lattice-like interval arrangement.

Next, the high density fabric was subjected to alkaline water treatment. The alkaline water treatment was carried out by immersing the high density fabric in an aqueous sodium hydroxide solution with a concentration of 3% by weight and a temperature of 65° C., and then holding the same for 240 minutes while gently stirring. After the treatment, the high density fabric was sufficiently washed with water, and then subjected to dry treatment at 70° C. for 90 minutes.

Next, a diluted solution of tris(2-hydroxyethyl)methyl ammonium bis(trifluoromethanesulfonyl)imide represented by the following structural formula was produced.

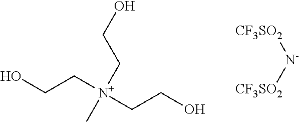

The dilution was carried out by mixing and stirring 1% by weight of the tris(2-hydroxyethyl)methyl ammonium bis(trifluoromethanesulfonyl)imide to pure water.

Next, the high density fabric after subjected to the alkaline water treatment and dried was immersed in the diluted solution, and then subjected to dry treatment at 70° C. for 90 minutes.

The surface resistance value of the high density fabric after impregnated with the tris(2-hydroxyethyl)methyl ammonium bis(trifluoromethanesulfonyl)imide which is an ionic liquid and dried was 5×10⁴ Ω/sq.

Further, the high density fabric impregnated with the ionic liquid was subjected to 42 kHz ultrasonic treatment in water for 10 minutes. Then, the SEM observation of the fabric surface before and after the ultrasonic treatment and the fabric surface before impregnated with the ionic liquid was performed and the element map image of carbon, oxygen, sulfur, and fluorine was created.

From the SEM observation of the fabric before impregnated with the ionic liquid, the carbon nanotubes which were three-dimensionally entangled were observed from the surface of the electrically conductive fibers constituting the fabric. From the element map of the surface, carbon and oxygen were measured from the entire fiber surface.

Next, it was confirmed from the SEM observation of the fabric after impregnated with the ionic liquid and before subjected to the ultrasonic treatment that the ionic liquid was present on the surface of the carbon nanotubes which were three-dimensionally entangled from the surface of the electrically conductive fibers constituting the fabric.

From the element map image, carbon, oxygen, sulfur, and fluorine were measured from the entire fiber surface. From the fact that sulfur and fluorine are not present on the surface of the carbon nanotubes and are elements constituting the ionic liquid, it is considered that the ionic liquid is present. More specifically, it was confirmed that the ionic liquid was present on the entire surface of the electrically conductive fibers.

Next, similarly as in the fabric before subjected to the ultrasonic treatment, it was confirmed from the SEM observation of the fabric after subjected to the ultrasonic treatment that the ionic liquid was present on the surface of the carbon nanotubes which were three-dimensionally entangled from the surface of the electrically conductive fibers constituting the fabric.

From the element map image, carbon, oxygen, sulfur, and fluorine were measured from the entire fiber surface. It is imagined from this fact that the ionic liquid is present on the surface of the carbon nanotubes and adheres to the surface of the carbon nanotubes by chemical bonding.

Next, the high density fabric before and after impregnated with the ionic liquid was evaluated for fire retardant properties. The evaluation of fire retardant properties was carried out by the oxygen index combustion test method which measures the oxygen index defined by the minimum oxygen concentration (capacity %) required for materials to maintain combustion.

As a result of the measurement, the oxygen index was 19.0 before impregnated with the ionic liquid and the oxygen index was 22.5 after impregnated with the ionic liquid. More specifically, the result in which the fire retardant properties improve by impregnating the fabric with the ionic liquid was obtained.

### Comparative Example 1

A high density fabric impregnated with an ionic liquid was produced in the same manner as in EXAMPLE 1, except changing the ionic liquid in EXAMPLE 1 to choline bis(trifluoromethylsulfonyl)imide represented by the following structural formula.

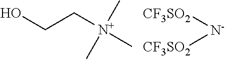

The surface resistance value of the fabric was 5×10⁴ Ω/sq.

Next, the high density fabric impregnated with the ionic liquid was subjected to ultrasonic treatment in water in the same manner as in EXAMPLE 1. After the ultrasonic treatment, the SEM observation of the surface of the electrically conductive fibers constituting the fabric and the element map measurement were performed. As a result, the ionic liquid was not present on the surface of the electrically conductive fibers and sulfur and fluorine which are constituent elements of the ionic liquid were not measured from the elemental map measurement.

### Example 2

Polyethylene terephthalate resin pellets having an intrinsic viscosity (hereinafter abbreviated as an “IV value”) of 0.8, a diameter of 3 mm, and a length of 5 mm are freeze-pulverized, and then classified to thereby produce fine power having a particle diameter of 150 μm or lower.

Next, the polyethylene terephthalate fine powder having a particle diameter of 150 μm or lower and carbon nanotubes having a length of 5 μm or lower, an average length of 3 μm, an aspect ratio of 400 or lower, and an average aspect ratio of 200 were dry-blended in such a manner that the proportion of the carbon nanotubes was 4% by weight.

Thereafter, by kneading and melting by a biaxial extruder, polyethylene terephthalate resin compound pellets in which the carbon nanotubes were uniformly dispersed were produced.

Next, the polyethylene terephthalate resin compound pellets in which the carbon nanotubes were uniformly dispersed were dried at 140° C. for 4 hours.

Next, the polyethylene terephthalate resin compound pellets in which the carbon nanotubes were uniformly dispersed were introduced into a biaxial extruder, and then a molten substance of the polyethylene terephthalate resin pellets in which the carbon nanotubes were uniformly dispersed was discharged from a melt spinning nozzle having a round spinneret having an opening diameter of 0.3 mm and having 36 holes at a spinning temperature of 290° C. for spinning.

The obtained spun yarn was cooled and solidified by cooling air having an air temperature of 25° C. and an air speed of 0.5 mm/second using a cooling device having a cooling length of 1 m, an oil agent (Effective component: 10% by weight concentration) was attached thereto, and then the yarn was wound at 1000 m/minute, thereby producing an undrawn multifilament yarn having a fiber diameter of 38 μm.

The obtained multifilament yarn was thermally drawn at a temperature of 150° C. in such a manner that the drawing ratio was twice, thereby producing a multifilament yarn containing 36 electrically conductive fibers with a fiber diameter of 27 μm.

Next, a high density fabric was produced into which the multifilament yarn containing the electrically conductive fibers with a fiber diameter of 27 μm was inserted lengthwise and widthwise in a lattice-like interval arrangement.

Next, the high density fabric was subjected to alkaline water treatment. The alkaline water treatment was carried out by immersing the high density fabric in an aqueous sodium hydroxide solution with a concentration of 3% by weight and a temperature of 65° C., and then holding the same for 240 minutes while gently stirring. After the treatment, the high density fabric was sufficiently washed with water, and then subjected to dry treatment at 70° C. for 90 minutes.

Next, a diluted solution of 1-(2-hydroxyethyl)-3-(2-hydroxyethyl)imidazolium bis(trifluoromethanesulfonyl)imide which is an ionic liquid having a hydroxyl group at the terminal of R5 and R7 in General Formula (2) was produced.

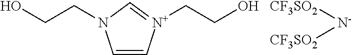

The dilution was carried out by mixing and stirring 1% by weight of the 1-(2-hydroxyethyl)-3-(2-hydroxyethyl)imidazolium bis(trifluoromethanesulfonyl)imide to pure water.

Next, the high density fabric after subjected to the alkaline water treatment and dried was immersed in the diluted solution, and then subjected to dry treatment at 70° C. for 90 minutes.

The surface resistance value of the high density fabric after impregnated with the 1-(2-hydroxyethyl)-3-(2-hydroxyethyl)imidazolium bis(trifluoromethanesulfonyl)imide which is an ionic liquid and dried was 7×10⁴ Ω/sq.

Further, the high density fabric impregnated with the ionic liquid was subjected to 42 kHz ultrasonic treatment in water for 10 minutes. Then, the SEM observation of the fabric surface before and after the ultrasonic treatment and the fabric surface before impregnated with the ionic liquid was performed and the element map image of carbon, oxygen, sulfur, and fluorine was created. From the SEM observation of the fabric before impregnated with the ionic liquid, the carbon nanotubes which were three-dimensionally entangled were observed from the surface of the electrically conductive fibers constituting the fabric. From the element map of the surface, carbon and oxygen were measured from the entire fiber surface.

Next, it was confirmed from the SEM observation of the fabric after impregnated with the ionic liquid and before subjected to the ultrasonic treatment that the ionic liquid was present on the surface of the carbon nanotubes which were three-dimensionally entangled from the surface of the electrically conductive fibers constituting the fabric. From the element map image, carbon, oxygen, sulfur, and fluorine were measured from the entire fiber surface. From the fact that sulfur and fluorine are not present on the surface of the carbon nanotubes and are elements constituting the ionic liquid, it was shown that the ionic liquid was present on the entire surface of the electrically conductive fibers.

Next, similarly as in the fabric before subjected to the ultrasonic treatment, it was confirmed from the SEM observation of the fabric after subjected to the ultrasonic treatment that the ionic liquid was present on the surface of the carbon nanotubes which were three-dimensionally entangled from the surface of the electrically conductive fibers constituting the fabric.

From the element map image, carbon, oxygen, sulfur, and fluorine were measured from the entire fiber surface. It is imagined from this fact that the ionic liquid is present on the surface of the carbon nanotubes and also firmly adheres to the surface of the carbon nanotubes by chemical bonding in such a manner that bleed-out does not occur in the ultrasonic treatment.

Next, the high density fabric before and after impregnated with the ionic liquid was evaluated for fire retardant properties. The evaluation of fire retardant properties was carried out by the oxygen index combustion test method which measures the oxygen index defined by the minimum oxygen concentration (capacity %) required for materials to maintain combustion.

As a result of the measurement, the oxygen index was 19.0 before impregnated with the ionic liquid and the oxygen index was 22.5 after impregnated with the ionic liquid.

The result showed that the fire retardant properties clearly improve by impregnating the fabric with the ionic liquid.

### Comparative Example 2

A high density fabric impregnated with an ionic liquid was produced in the same manner as in EXAMPLE 2, except using the following 1-(2-hydroxyethyl)-3-methylimidazolium bis(trifluoromethanesulfonyl)imide which is an ionic liquid having a hydroxyl group at the terminal of R5 and not having a hydroxyl group at the terminal of R7 in General Formula (2) as the ionic liquid. The surface resistance value of the fabric was 8×10⁴ Ω/sq.

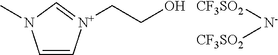

Next, the high density fabric impregnated with the ionic liquid was subjected to ultrasonic treatment in water in the same manner as in EXAMPLE 1. After the ultrasonic treatment, the SEM observation of the surface of the electrically conductive fibers constituting the fabric and the element map measurement were performed. As a result, the ionic liquid was not present on the surface of the electrically conductive fibers and sulfur and fluorine which are constituent elements of the ionic liquid were not measured also from the elemental map measurement.

### Comparative Example 3

A high density fabric impregnated with an ionic liquid was produced in the same manner as in EXAMPLE 2, except using the following 1-ethyl-3-methylimidazolium bis(fluorosulfonyl)imide which is an ionic liquid not having a hydroxyl group at the terminal of R5 to R10 in General Formula (2) as the ionic liquid. The surface resistance value of the fabric was 7×10⁴ Ω/sq.

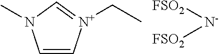

Next, the high density fabric impregnated with the ionic liquid was subjected to ultrasonic treatment in water in the same manner as in EXAMPLE 2. After the ultrasonic treatment, the SEM observation of the surface of the electrically conductive fibers constituting the fabric and the element map measurement were performed.

As a result, the ionic liquid was not present on the surface of the electrically conductive fibers and sulfur and fluorine which are constituent elements of the ionic liquid were not measured also from the elemental map measurement.

### Example 3

Polyethylene terephthalate resin pellets having an intrinsic viscosity (hereinafter abbreviated as an “IV value”) of 0.8, a diameter of 3 mm, and a length of 5 mm are freeze-pulverized, and then classified to thereby produce fine power having a particle diameter of 150 μm or lower. Next, the polyethylene terephthalate fine powder having a particle diameter of 150 μm or lower and carbon nanotubes having a length of 5 μm or lower, an average length of 3 μm, an aspect ratio of 400 or lower, and an average aspect ratio of 200 were dry-blended in such a manner that the proportion of the carbon nanotubes was 4% by weight. Thereafter, by kneading and melting by a biaxial extruder, polyethylene terephthalate resin compound pellets in which the carbon nanotubes were uniformly dispersed were produced.

Next, the polyethylene terephthalate resin compound pellets in which the carbon nanotubes were uniformly dispersed were dried at 140° C. for 4 hours.

Next, the polyethylene terephthalate resin compound pellets in which the carbon nanotubes were uniformly dispersed were introduced into a biaxial extruder, and then a molten substance of the polyethylene terephthalate resin pellets in which the carbon nanotubes were uniformly dispersed was discharged from a melt spinning nozzle having a round spinneret having an opening diameter of 0.3 mm and having 36 holes at a spinning temperature of 290° C. for spinning.

The obtained spun yarn was cooled and solidified by cooling air having an air temperature of 25° C. and an air speed of 0.5 mm/second using a cooling device having a cooling length of 1 m, an oil agent (Effective component: 10% by weight concentration) was attached thereto, and then the yarn was wound at 1000 m/minute, thereby producing an undrawn multifilament yarn having a fiber diameter of 38 μm.

The obtained multifilament yarn was thermally drawn at a temperature of 150° C. in such a manner that the drawing ratio was twice, thereby producing a multifilament yarn containing 36 electrically conductive fibers with a fiber diameter of 27 μm.

Next, a high density fabric was produced into which the multifilament yarn containing the electrically conductive fibers with a fiber diameter of 27 μm was inserted lengthwise and widthwise in a lattice-like interval arrangement.

Next, the high density fabric was subjected to alkaline water treatment. The alkaline water treatment was carried out by immersing the high density fabric in an aqueous sodium hydroxide solution with a concentration of 3% by weight and a temperature of 65° C., and then holding the same for 240 minutes while gently stirring.

After the treatment, the high density fabric was sufficiently washed with water, and then subjected to dry treatment at 70° C. for 90 minutes.

Next, a diluted solution of the following 1-(2-hydroxyethyl)pyridinium bis(trifluoromethanesulfonyl)imide which is an ionic liquid having a hydroxyl group at the terminal of R10 in General Formula (3) was produced.

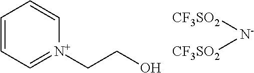

The dilution was carried out by mixing and stirring 1% by weight of the 1-(2-hydroxyethyl)pyridinium bis(trifluoromethanesulfonyl)imide to pure water.

Next, the high density fabric after subjected to the alkaline treatment and dried was immersed in the diluted solution, and then subjected to dry treatment at 70° C. for 90 minutes.

The surface resistance value of the high density fabric after impregnated with the 1-(2-hydroxyethyl)pyridinium bis(trifluoromethanesulfonyl)imide which is an ionic liquid and dried was 5×10⁴ Ω/sq.

Further, the high density fabric impregnated with the ionic liquid was subjected to 42 kHz ultrasonic treatment in water for 10 minutes. Then, the SEM observation of the fabric surface before and after the ultrasonic treatment and the fabric surface before impregnated with the ionic liquid was performed and the element map image of carbon, oxygen, sulfur, and fluorine was created.

From the SEM observation of the fabric before impregnated with the ionic liquid, the carbon nanotubes which were three-dimensionally entangled were observed from the surface of the electrically conductive fibers constituting the fabric. From the element map of the surface, carbon and oxygen were measured from the entire fiber surface.

Next, it was confirmed from the SEM observation of the fabric after impregnated with the ionic liquid and before subjected to the ultrasonic treatment that the ionic liquid was present on the surface of the carbon nanotubes which were three-dimensionally entangled from the surface of the electrically conductive fibers constituting the fabric. From the element map image, carbon, oxygen, sulfur, and fluorine were measured from the entire fiber surface. From the fact that sulfur and fluorine are not present on the surface of the carbon nanotubes and are elements constituting the ionic liquid, it was shown that the ionic liquid was present on the entire surface of the electrically conductive fibers.

Next, similarly as in the fabric before subjected to the ultrasonic treatment, it was confirmed from the SEM observation of the fabric after subjected to the ultrasonic treatment that the ionic liquid was present on the surface of the carbon nanotubes which were three-dimensionally entangled from the surface of the electrically conductive fibers constituting the fabric.

From the element map image, carbon, oxygen, sulfur, and fluorine were measured from the entire fiber surface. It is imagined from this fact that the ionic liquid is present on the surface of the carbon nanotubes and also firmly adheres to the surface of the carbon nanotubes by chemical bonding in such a manner that bleed-out does not occur in the ultrasonic treatment.

Next, the high density fabric before and after impregnated with the ionic liquid was evaluated for fire retardant properties. The evaluation of fire retardant properties was carried out by the oxygen index combustion test method which measures the oxygen index defined by the minimum oxygen concentration (capacity %) required for materials to maintain combustion.

As a result of the measurement, the oxygen index was 19.0 before impregnated with the ionic liquid and the oxygen index was 22.5 after impregnated with the ionic liquid. The result showed that the fire retardant properties clearly improve by impregnating the fabric with the ionic liquid.

### Example 4

A high density fabric impregnated with an ionic liquid was produced in the same manner as in EXAMPLE 3, except using the following 1-(3-hydroxypropyl)pyridium bis(trifluoromethanesulfonyl)imide which is an ionic liquid having a hydroxyl group at the terminal of R10 in General Formula (3) as the ionic liquid in EXAMPLE 3. The surface resistance value of the fabric was 7×10⁴ Ω/sq.

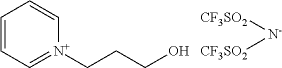

Next, the high density fabric impregnated with the ionic liquid was subjected to ultrasonic treatment in water in the same manner as in EXAMPLE 3. After the ultrasonic treatment, the SEM observation of the surface of the electrically conductive fibers constituting the fabric and the element map measurement were performed.

As a result, it was confirmed that the ionic liquid was not present on the surface of the carbon nanotubes. It is imagined from the result that 1-(3-hydroxypropyl)pyridium bis(trifluoromethanesulfonyl)imide adheres to the surface of the carbon nanotubes by chemical bonding.

Next, the evaluation of fire retardant properties was carried out by the oxygen index combustion test method in the same manner as in EXAMPLE 3. As a result, the oxygen index was 22.5. The result showed that the fire retardant properties clearly improve by impregnating the fabric with the ionic liquid.

### Comparative Example 4

A high density fabric impregnated with an ionic liquid was produced in the same manner as in EXAMPLE 3, except using the following 1-ethyl-3-hydroxy-pyridinium ethyl sulfonate which is an ionic liquid not having a hydroxyl group at the terminal of R10 and having a hydroxyl group at the terminal of R12 in General Formula (3) as the ionic liquid in EXAMPLE 3. The surface resistance value of the fabric was 5×10⁴ Ω/sq.

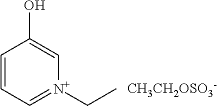

Next, the high density fabric impregnated with the ionic liquid was subjected to ultrasonic treatment in water in the same manner as in EXAMPLE 3. After the ultrasonic treatment, the SEM observation of the surface of the electrically conductive fibers constituting the fabric and the element map measurement were performed.

As a result, the ionic liquid was not present on the surface of the electrically conductive fibers and sulfur which is a constituent element of the ionic liquid was not measured from the element map measurement.

### Comparative Example 5

A high density fabric impregnated with an ionic liquid was produced in the same manner as in EXAMPLE 3, except using 1-ethyl-3-methylpyridium trifluorobutanesulfonate represented by the following formula (5) which is an ionic liquid not having a hydroxyl group at the terminal of R10 to R15 in General Formula (3) in EXAMPLE 3. The surface resistance value of the fabric was 2×10⁴ Ω/sq.

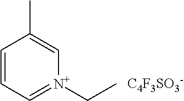

Next, the high density fabric impregnated with the ionic liquid was subjected to ultrasonic treatment in water in the same manner as in EXAMPLE 1. After the ultrasonic treatment, the SEM observation of the surface of the electrically conductive fibers constituting the fabric and the element map measurement were performed. As a result, the ionic liquid was not present on the surface of the electrically conductive fibers and sulfur and fluorine which are constituent elements of the ionic liquid were not measured also from the element map measurement.

### Example 5

Polyethylene terephthalate resin compound pellets in which carbon nanotubes were uniformly dispersed in the same manner as in EXAMPLE 1, except changing the content of the carbon nanotubes to 6.0% by weight in EXAMPLE 1.

Next, the pellets were dried at 140° C. for 4 hours, supplied to a uniaxial extruder having a T-die and heated to a temperature of 285° C., and then melted, thereby producing an undrawn film.

Next, the undrawn film was drawn by 4 times in the vertical direction at 150° C., and further drawn by 4 times in the horizontal direction at 150° C., thereby producing a 300 μm thick drawn film.

Next, the drawn film was subjected to alkaline water treatment in the same manner as in EXAMPLE 1. Thereafter, the film was immersed in a diluted solution of an ionic liquid produced in the same manner as in EXAMPLE 1 for 5 minutes, and then subjected to dry treatment.

The surface resistivity of the drawn film after impregnated with the ionic liquid and dried was 9×10¹ Ω/sq.

### Example 6

Polyethylene terephthalate resin compound pellets in which carbon nanotubes were uniformly dispersed in the same manner as in EXAMPLE 2, except changing the content of the carbon nanotubes to 6.0% by weight in EXAMPLE 2.

Next, the pellets were dried at 140° C. for 4 hours, supplied to a uniaxial extruder having a T-die and heated to a temperature of 285° C., and then melted, thereby producing an undrawn film.

Next, the undrawn film was drawn by 4 times in the vertical direction at 150° C., and further drawn by 4 times in the horizontal direction at 150° C., thereby producing a 300 μm thick drawn film.

Next, the drawn film was subjected to alkaline water treatment in the same manner as in EXAMPLE 1. Thereafter, the film was immersed in a diluted solution of an ionic liquid produced in the same manner as in EXAMPLE 2 for 5 minutes, and then subjected to dry treatment.

The surface resistivity of the drawn film after impregnated with the ionic liquid and dried was 9×10¹ Ω/sq.

### Example 7

Polyethylene terephthalate resin compound pellets in which carbon nanotubes were uniformly dispersed in the same manner as in EXAMPLE 3, except changing the content of the carbon nanotubes to 6.0% by weight in EXAMPLE 3.

Next, the pellets were dried at 140° C. for 4 hours, supplied to a uniaxial extruder having a T-die and heated to a temperature of 285° C., and then melted, thereby producing an undrawn film.

Next, the undrawn film was drawn by 4 times in the vertical direction at 150° C., and further drawn by 4 times in the horizontal direction at 150° C., thereby producing a 300 μm thick drawn film.

Next, the drawn film was subjected to alkaline water treatment in the same manner as in EXAMPLE 1. Thereafter, the film was immersed in a diluted solution of an ionic liquid produced in the same manner as in EXAMPLE 3 for 5 minutes, and then subjected to dry treatment.

The surface resistivity of the drawn film after impregnated with the ionic liquid and dried was 8×10¹ Ω/sq.

According to the invention, since the carbon nanotubes holding the ionic liquid are contained in the surface layer portion, a polyester molded body having high fire retardant properties and a low surface resistance value can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-275098 filed Dec. 15, 2011, No. 2011-275099 filed Dec. 15, 2011, No. 2011-275100 filed Dec. 15, 2011 and No. 2012-227978 filed Oct. 15, 2012, which are hereby incorporated by reference herein in their entirety.

What is claimed is:

1. A molded body, comprising:
a base material;
a first region covering the base material; and
a second region covering the first region, wherein
the first region comprises the base material and carbon nanotubes, and
the second region comprises carbon nanotubes and an ionic liquid.

2. A molded body, comprising:
a first region; and
a second region disposed covering the first region, wherein
the first region consists of polyester and carbon nanotubes, and
the second region consists of carbon nanotubes and an ionic liquid.

3. The molded body according to claim 1, wherein the ionic liquid is represented by the following general formula (1), 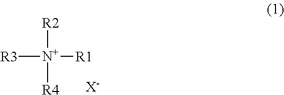
wherein, in Formula (1), R1 to R4 each are independently selected from a hydrogen atom and an alkyl group having carbon atoms of 1 or more and 4 or lower,
at least two groups of R1 to R4 are primary alcohols having carbon atoms of 1 or more and 4 or lower, and
X⁻ represents an anion.

4. The molded body according to claim 1, wherein the ionic liquid is represented by the following general formula (2), 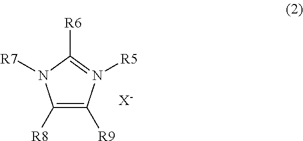
wherein, in Formula (2), R5 and R7 each are independently selected from functional groups having a hydroxyl group at the terminal of an alkyl group having carbon atoms of 1 or more and 4 or lower,
R6, R8, and R9 each are independently selected from hydrogen or an alkyl group having carbon atoms of 1 or more and 4 or lower, and
X⁻ represents an anion.

5. The molded body according to claim 1, wherein the ionic liquid is represented by the following general formula (3), 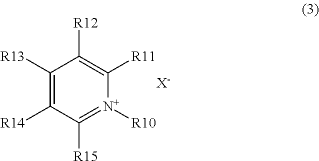
wherein, in Formula (3), R10 is selected from functional groups having a hydroxyl group at the terminal of an alkyl group having carbon atoms of 1 or more and 4 or lower,
R11, R12, R13, R14, and R15 each are independently selected from hydrogen or an alkyl group having carbon atoms of 1 or more and 4 or lower, and
X⁻ represents an anion.

6. The molded body according to claim 1, wherein the carbon nanotubes are three-dimensionally entangled with the other carbon nanotubes.

7. The molded body according to claim 2, wherein the ionic liquid is represented by the following general formula 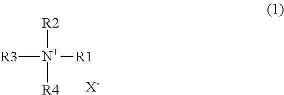
wherein, in Formula (1), R1 to R4 each are independently selected from a hydrogen atom and an alkyl group having carbon atoms of 1 or more and 4 or lower,
at least two groups of R1 to R4 are primary alcohols having carbon atoms of 1 or more and 4 or lower, and
X⁻ represents an anion.

8. The molded body according to claim 2, wherein the ionic liquid is represented by the following general formula (2), 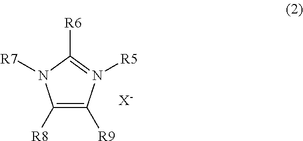
wherein, in Formula (2), R5 and R7 each are independently selected from functional groups having a hydroxyl group at the terminal of an alkyl group having carbon atoms of 1 or more and 4 or lower,
R6, R8, and R9 each are independently selected from hydrogen or an alkyl group having carbon atoms of 1 or more and 4 or lower, and
X⁻ represents an anion.

9. The molded body according to claim 2, wherein the ionic liquid is represented by the following general formula (3), 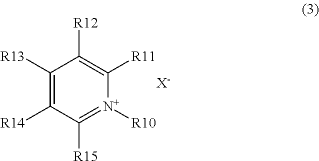
wherein, in Formula (3), R10 is selected from functional groups having a hydroxyl group at the terminal of an alkyl group having carbon atoms of 1 or more and 4 or lower,
R11, R12, R13, R14, and R15 each are independently selected from hydrogen or an alkyl group having carbon atoms of 1 or more and 4 or lower, and
X⁻ represents an anion.

10. The molded body according to claim 2, wherein the carbon nanotubes are three-dimensionally entangled with the other carbon nanotubes.

11. The molded body according to claim 3, wherein the ionic liquid is represented by the following structural formula

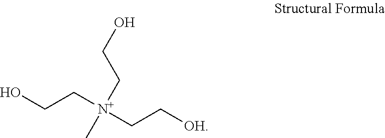

12. The molded body according to claim 1, wherein the anion is (CF₃SO₂)₂N.

13. The molded body according to claim 2, wherein the anion is (CF₃SO₂)₂N.

14. The molded body according to claim 1, wherein a surface resistance value is 10⁰ Ω/sq. to 10⁷ Ω/sq.

15. The molded body according to claim 2, wherein a surface resistance value is 10⁰ Ω/sq. to 10⁷ Ω/sq.
